(19) United States
(12) Patent Application Publication
(10) Pub. No.: US 2015/0287345 A1
(43) Pub. Date: Oct. 8, 2015

(54) APPARATUS FOR CORRECTING COLOR-BLINDNESS

(71) Applicant: Enrico Tanuwidjaja, San Diego, CA (US)

(72) Inventor: Enrico Tanuwidjaja, San Diego, CA (US)

(21) Appl. No.: 14/682,090

(22) Filed: Apr. 8, 2015

Related U.S. Application Data
(60) Provisional application No. 61/976,507, filed on Apr. 8, 2014.

(51) Int. Cl. G09B 21/04; G06F 3/16; G06F 3/0484; H04N 9/76; G06T 11/00

(52) U.S. Cl. CPC G09B 21/04; H04N 9/76; G06T 11/001; G06F 3/04842; G06F 3/167; G06T 2200/24

(57) ABSTRACT

A novel method, apparatus, and system are disclosed for a color filtering method to provide assistance to color-blind users in perceiving colors they have difficulty seeing using augmented reality technology. The color filtering method comprises accessing camera data; converting color space of a plurality of pixels of color in the camera data to hue, saturation, and value (HSV) color space; having a user choose at least one color of interest to convert to at least one replacement color; testing the plurality of the pixels of the at least one color of interest and the plurality of the pixels of the at least one replacement color using a formula; replacing the plurality of the pixels of the at least one color of interest with a plurality of the pixels of the at least one replacement color; and displaying a preview of the plurality of the pixels of the at least one replacement color to the color-blind user in real time.

This non provisional patent application claims the benefit of priority to earlier filed provisional patent application entitled, “APPARATUS FOR CORRECTING COLOR-BLINDNESS”, filed Apr. 8, 2014, s/n 61/976,507, which is hereby incorporated by reference in its entirety.

### BRIEF DESCRIPTION OF THE DRAWINGS

Embodiments of the present disclosure will be more readily understood by reference to the following figures, in which like reference numbers and designations indicate like elements.

FIG. 1a is an unfiltered image that displays how a color-blind user might not notice an uncooked portion of a piece of meat.

FIG. 1b illustrates a method for assisting the color-blind user in perceiving colors, according to one embodiment of the present teachings.

FIG. 1c illustrates a method for assisting the color-blind user in perceiving colors, according to one embodiment of the present teachings.

FIG. 2 illustrates a system for assisting the color-blind user in perceiving colors, according to one embodiment of the present teachings.

FIG. 3 illustrates a method for assisting the color-blind user in perceiving colors, according to one embodiment of the present teachings.

FIG. 6a illustrates an apparatus for assisting the color-blind user in perceiving colors, according to one embodiment of the present teachings.

FIG. 6b illustrates an apparatus for assisting the color-blind user in perceiving colors, according to one embodiment of the present teachings.

FIG. 6c illustrates an apparatus for assisting the color-blind user in perceiving colors, according to one embodiment of the present teachings.

FIG. 6d illustrates an apparatus for assisting the color-blind user in perceiving colors, according to one embodiment of the present teachings.

FIG. 7 illustrates a method for assisting the color-blind user in perceiving colors, according to one embodiment of the present teachings.

FIG. 8 illustrates a system for assisting the color-blind user in perceiving colors, according to one embodiment of the present teachings.

### DETAILED DESCRIPTION

### Overview

The present teachings disclose a method, apparatus, system and article of manufacture for assisting a color-blind user in perceiving colors in real time using an eyewear and/or a computing device. The present teachings describe how to filter colors to aid the color-blind user using augmented reality technology. Utilizing the eyewear and/or the computing device, the present teachings describe how to access camera readings, process every pixel in a scene view, and display an altered view to the color-blind user in real time.

Color-blindness is a condition that makes it difficult for some people to distinguish certain colors. There are several forms of color-blindness, which can have consequences that range from mild to dangerous. For example, a person suffering from protanomaly cannot perceive red clearly. A person with protanopia has difficulty distinguishing red from green, which can be a safety issue when driving. Other forms of color blindness are deuteranopia, the inability to see green; deuteranomaly, the confusion in red and green; tritanopia, the blue-yellow challenge; and tritanomaly, the confusion in blue and yellow. The present disclosure overcomes these issues by filtering scene views chosen by the color-blind user and making colors she chooses easily identifiable to her.

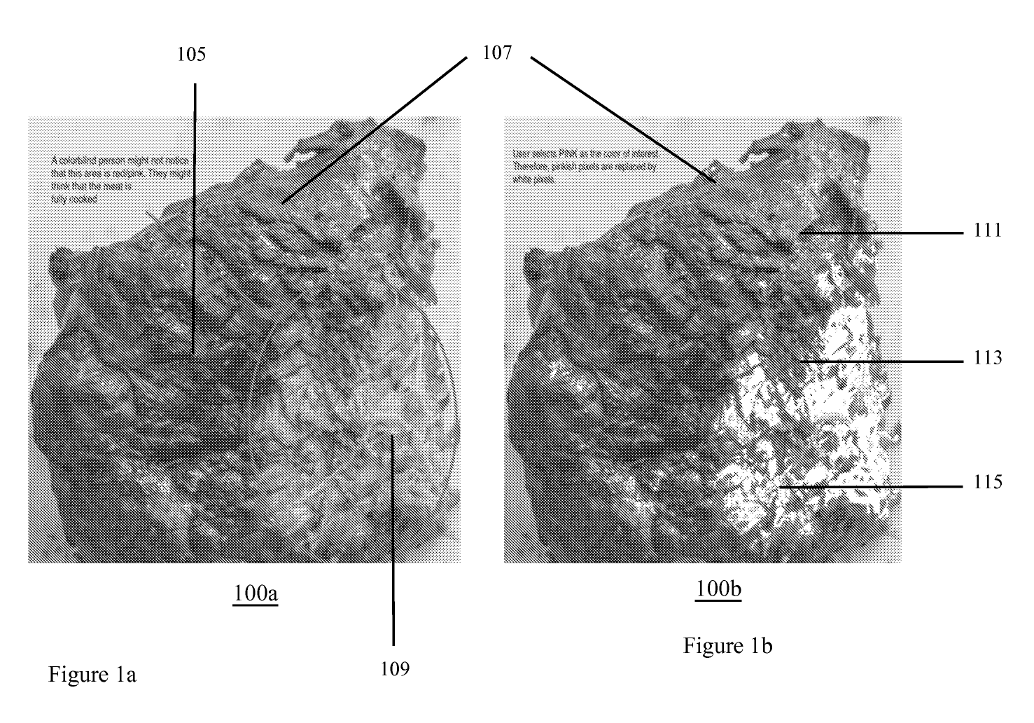

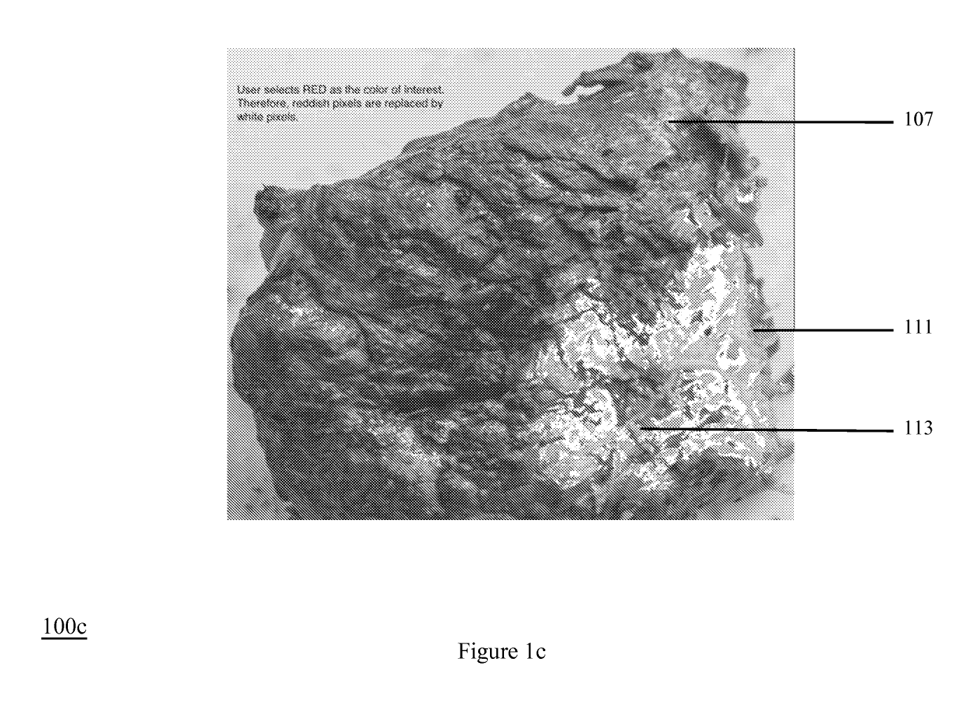

Referring now generally to FIG. 1a, the present teachings disclose a method for assisting a color-blind user in perceiving colors 100a. The method for assisting a color-blind user in perceiving colors 100a generally comprises a color perceived by a user who is not color-blind versus a color perceived by the color-blind user. The present teachings disclose helping a color-blind user distinguish between colors, wherein the color-blind user might not have the ability to discern between colors, such as, for example, brown and pink. In one embodiment, unfiltered image 105 displays how the color-blind user might not notice an uncooked portion 109 of a piece of meat 107. “Unfiltered” means an image is in its normal, untouched state.

Referring now generally to FIG. 1b, in one embodiment of the present teachings, a method for assisting a color-blind user in perceiving colors 100b is disclosed. The method for assisting the color-blind user in perceiving colors 100b generally comprises pixels of at least one color of interest 113 that are replaced by pixels of at least one replacement color 115 as chosen by a color-blind user. “Color of interest” means a color or colors within a certain area that the color-blind user chooses to determine. For example, the at least one color of interest 113 of the color-blind user may be the color or colors toward an end portion in a piece of meat. The at least one color of interest 113 may be basic colors, such as red, green, blue, yellow, orange, purple, brown, pink, and grey. “Replacement color” means a color or colors that the color-blind user chooses as an alternate color or colors for the at least one color of interest 113. For example, a replacement color or colors may be red and/or blue. The at least one replacement color 115 may be basic colors, such as red, green, blue, yellow, orange, purple, brown, pink, and grey. The present teachings disclose that the at least one color of interest 113 and the at least one replacement color 115 are computed in parallel and mapped to a unique color or colors that may be specified by the color-blind user.

In one embodiment, filtered image 111 shows how the color-blind user may discern difference in colors. “Filtered” means a device that does not allow certain wavelengths of light to pass through has been used to display an image, thereby assisting the color-blind user to perceive certain colors. For example, the color-blind user chooses pink as the at least color of interest 113 and white as the at least one replacement color 115 on a piece of meat 107. Therefore, pink pixels are replaced by white pixels.

Referring now generally to FIG. 1c, the present teachings disclose a method for assisting a color-blind user in perceiving colors 100c. The method for assisting the color-blind user in perceiving colors 100c generally comprises, as described above, pixels of at least one color of interest 113 that are replaced by pixels of at least one replacement color 115 as chosen by a color-blind user. The pixels of the at least one color of interest 113 and the pixels of the at least one replacement color 115 may be easily identifiable by the color-blind user. For example, the color-blind user chooses red as the at least one color of interest 113 and white as the at least one replacement color 115 on a piece of meat 107. Therefore, red pixels are replaced by white pixels. In one embodiment, the pixels of the at least one replacement color 115 are flashing so that they may be more evident to the color-blind user. “Flashing” means alternating displays between an unfiltered image (FIG. 1a) and a filtered image (FIG. 1b) at a pre-determined time whereby the pixels of the at least one replacement color 115 flash on and off. The purpose of the flashing pixels is to assist the color-blind user in distinguishing colors.

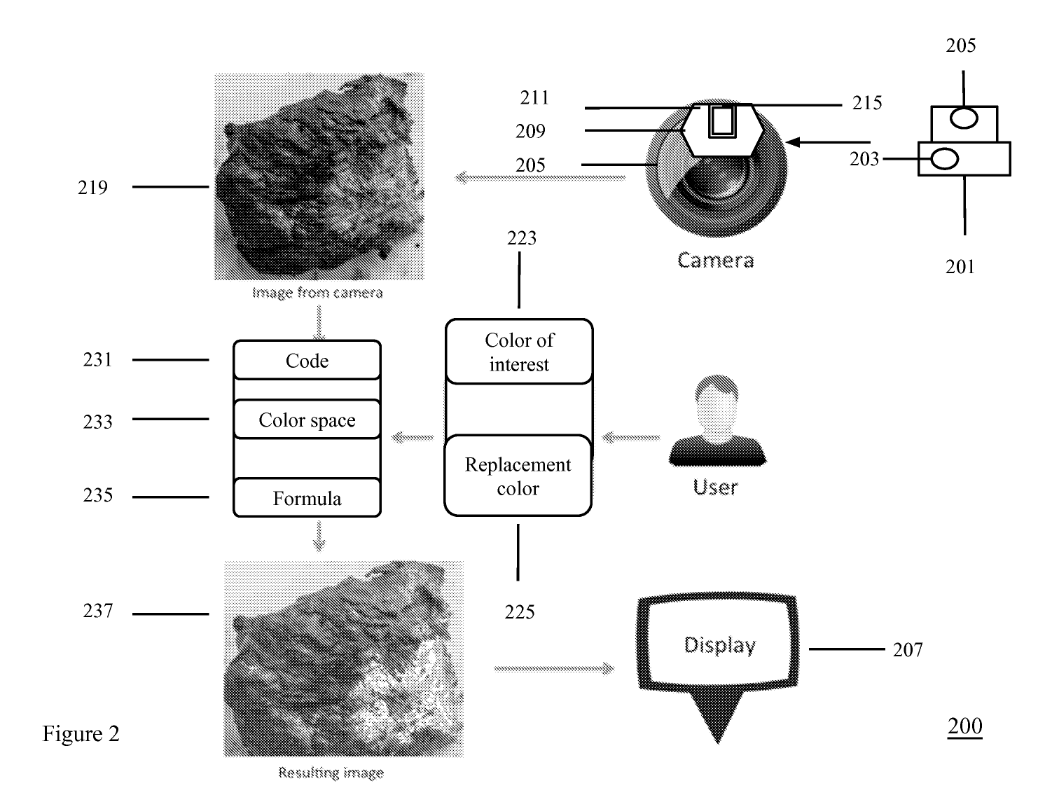

Referring now generally to FIG. 2, the present teachings disclose a system for assisting a color-blind user in perceiving colors 200. The system for assisting the color-blind user in perceiving colors 200 comprises at least one computing device 201. The at least one computing device 201 further comprises at least one processor 203, at least one camera 205, at least one display 207, and a color-blind user. The at least one computing device 201 may be, for example, a desktop computer, a laptop computer, a tablet, or a smartphone. The at least one processor 203 is a program that translates another program into an acceptable form by the at least one computing device 201. The at least one display 207 means a computer screen or a computer monitor.

The present teachings disclose that in one embodiment, the color-blind user is not wearing an eyewear. This means that colors she perceives are from the at least one display 207 that is connected to the at least one computing device 201. In one embodiment, the color-blind user may be at home in front of the at least one computing device 201 instead of, for example, driving.

The at least one camera 205 further comprises camera data 209, a plurality of pixels of at least one color 211, color space 215 for a plurality of pixels of the camera data 209, an image 219 from the at least one camera 205. “Color space” means an area that encompasses a range of colors. In one exemplary embodiment of the present teachings, the color-blind user may use graphical user interface. In another embodiment of the present teachings, the color-blind user may use voice commands. “Graphical user interface” refers to using icons and/or images instead of text when interacting with the at least one computing device 201. In one embodiment, the color-blind user communicates through the at least one computing device 201, for example, by using a keyboard or a touch screen. “Voice commands” means the color-blind user uses verbal communication with the at least one computing device 201. In one exemplary embodiment, the color-blind user utilizes voice commands when, for example, driving. In another exemplary embodiment, the image 219 from the camera data 209 of the at least one camera 205 displays an unfiltered image (FIG. 1a) of an object, for example, a piece of cooked meat showing an uncooked portion. The color-blind user might not be able to perceive the difference in colors, for example, between a cooked portion and an uncooked portion of a piece of meat (FIG. 1a and FIG. 1b).

The present teachings further disclose that the system for assisting the color-blind user in perceiving colors 200 further comprises at least one color of interest 223 in human language and at least one replacement color 225 in human language. “Human language” is a tongue spoken by the color-blind user, for example, English or Indonesian. The color-blind user views the image 219 from the at least one camera 205 and decides which colors to change. In one exemplary embodiment, the color-blind user may use graphical user interface to choose the at least one color of interest 223 in human language and replace it with the at least one replacement color 225 in human language. In another exemplary embodiment, the color-blind user may use voice commands to choose the at least one color of interest 223 in human language and replace it with the at least one replacement color 225 in human language. For example, the color-blind user has difficulty determining whether a section from the image 219 from the at least one camera 205 is fully cooked. The color-blind user may choose red as the at least one color of interest 223 and replace it with white as the at least one replacement color 225.

The present teachings disclose that the system for assisting the color-blind user in perceiving colors 200 further comprises a code 231 and a formula 235. The “code” is utilized in operating color modifications of the camera data 209. “Color modification” means changing a plurality of pixels from a plurality of pixels of the at least one color of interest 223 to a plurality of pixels of the at least one replacement color 225 as chosen by the color-blind user. The “formula” refers to a process of classifying a color by comparing hue, saturation, and value (HSV) with other thresholds. “HSV” is a group of components of the formula 235. “Threshold” means a limit or an end.

In one embodiment, the color-blind user accesses the camera data 209 using the code 231. Each pixel of the plurality of the pixels from the camera data 209 is examined using the formula 235. For each pixel of the plurality of the pixels from camera data 209, color space 233 of the plurality of pixels of the at least one color of interest 223 is converted to an HSV color space of the plurality of the pixels of the at least one replacement color 225 of the color-blind user and is showed as a resulting image 237. The resulting image 237 is showed as a preview to the color-blind user on the at least one display 207 of the at least one computing device 201 in real time. “Real time” means actual time as opposed to delayed time. In one embodiment, the formula 235 is used to test whether the plurality of the pixels of the at least one color of interest 223. The present teachings disclose that the pixels of the at least one color of interest 223 are flashing. In one embodiment, the formula 235 is used to test whether the plurality of the pixels is the at least one replacement color 225 of the color-blind user. The present teachings disclose that the pixels of the at least one color of interest 223 are flashing. The purpose of the flashing is to assist the color-blind user in distinguishing colors by providing an opportunity to the color-blind user to compare and contrast colors within a short range of time.

Described herein is an example of how the formula 235 is used. In one embodiment, let: [symbol] ∈[0,360], the hue of the pixel; [symbol] ∈[0,1], the saturation of the pixel; and [symbol] ∈[0,1], the value of the pixel. In some embodiments, for purposes of describing the system for assisting the color-blind user in perceiving colors 200, HSV and HSB are interchangeable terminology.

Once the appropriate thresholds are determined, the HSV values are checked whether they fall within the thresholds. If the at least one color of interest 223 of the color-blind user is, for example, red, using the formula 235, the HSV values are checked as follows:

335 <h <360 or 0<h<14

0.8 <s<1 or 0.8<s<1

0.4 <v<1 or 0.4 <v<1

If either condition is true, then the pixel can be classified as red. Red has two thresholds because it is located near a wraparound of an HSV spectrum. “Wraparound” is an area in a color wheel where red and violet merge.

HSV values below are used to classify the pixel as, for example, blue:

180 <h <241

0.3 <s <1

0.15 <v<1

The present teachings disclose that because each individual has a slightly different color perception, the thresholds above are subjective. Therefore, it is not necessary to use exactly the thresholds above for, for example, red or blue. “Color perception” means a range of colors that is classified as, for example, red by one individual is not exactly within the range of colors that is classified as, for example, red by another individual.

The formula 235 determines whether the plurality of the pixels fall within the at least one color of interest 233, for example, red. In one embodiment, using the formula 235, the plurality of the pixels from the camera data 209 fall within a color boundary of the at least color of interest 223. The “color boundary” is a point wherein a plurality of pixels changes, thereby determining color intensity. For example, red that is too light may be seen as a darker shade of pink.

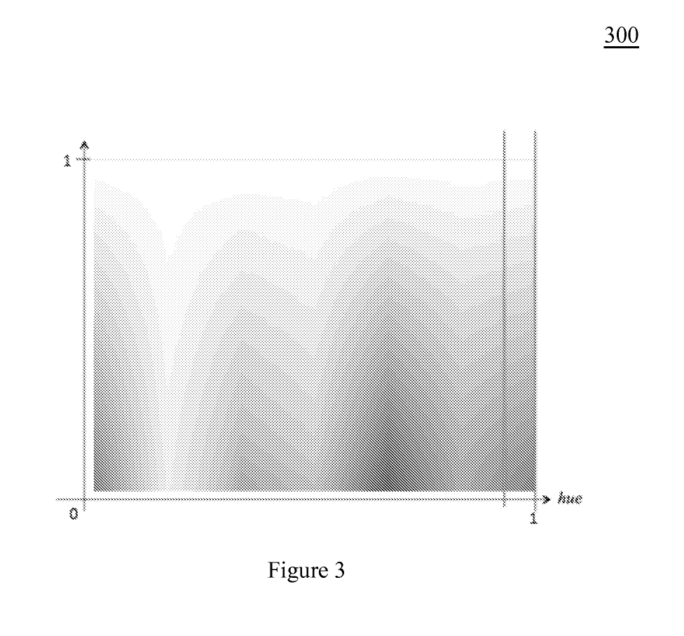

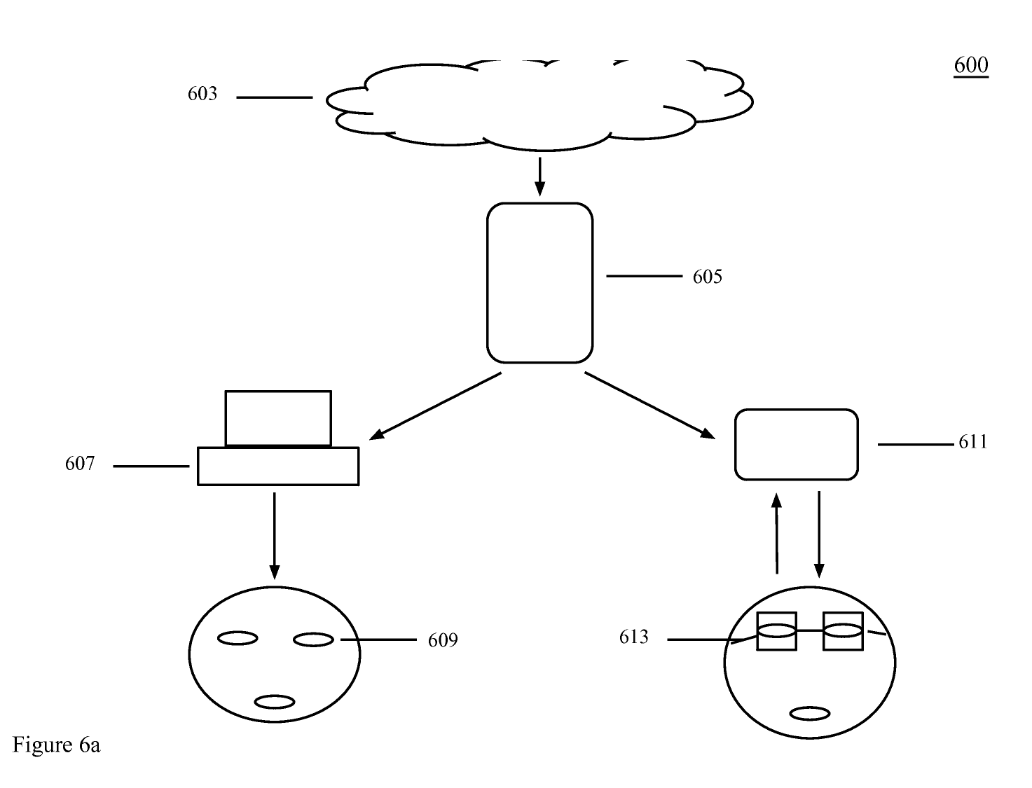

Referring now generally to FIG. 3, in one embodiment of the present teachings, a method for assisting a color-blind user in perceiving colors 300 is disclosed. The method for assisting the color-blind user in perceiving colors 300 comprises checking if hue, saturation, and value are within appropriate thresholds based on a color spectrum. For example, red may fall within 335 <h <360.

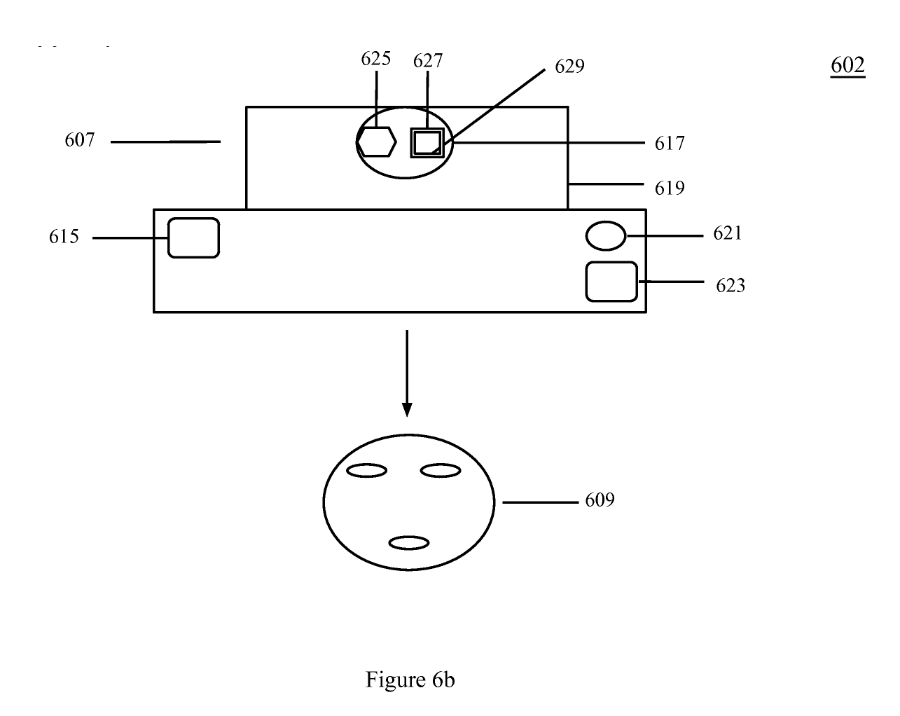

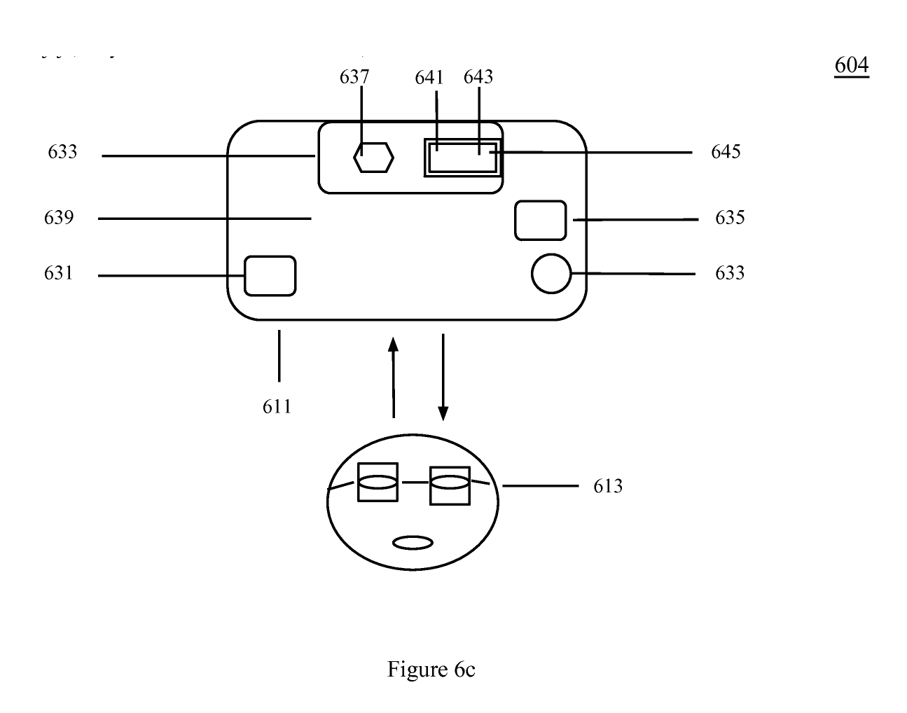

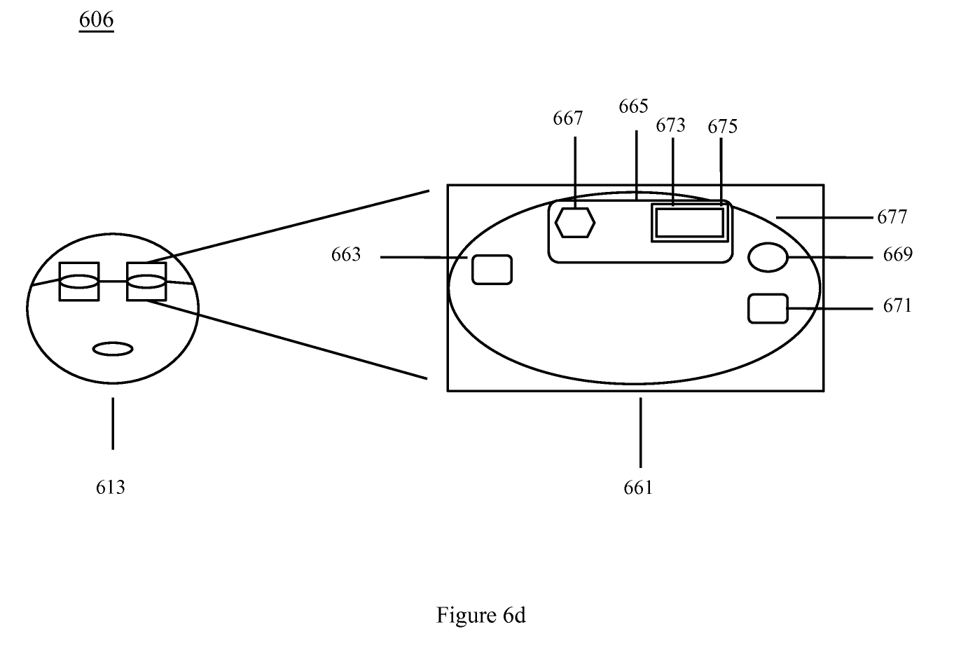

Referring now generally to FIG. 6a, one embodiment of an apparatus for assisting the color-blind user in perceiving colors 600 is disclosed. The apparatus for assisting the color-blind user in perceiving colors 600 generally comprises a cloud computing system 603, a computer server 605, at least one computing device 607, a color-blind user without an eyewear 609, at least one mobile device 611, and a color-blind user with an eyewear 613.

Referring now generally to FIG. 6b, in one embodiment of the teachings, an apparatus for assisting a color-blind user in perceiving colors 602 is disclosed. The apparatus for assisting the color-blind user in perceiving colors 602 generally comprises the color-blind user without an eyewear 609, at least one computing device 607 that has at least one processor 615, at least one camera 617, and at least one display 619. The apparatus for assisting the color-blind user in perceiving colors 602 has at least one code 621 and at least one formula 623. The at least one camera 617 of the at least one computing device 607 comprises camera data 625, at least one color 627, and a plurality of pixels 629 of the at least one color 627. The present teachings disclose that the color-blind user without the eyewear 609 may be in front of his at least one computing device 607.

Referring now generally to FIG. 6c, one embodiment of an apparatus for assisting a color-blind user in perceiving colors 604 is disclosed. The apparatus for assisting the color-blind user in perceiving colors 604 generally comprises the color-blind user with an eyewear 613, the at least one mobile device 611 that has at least one processor 635, at least one camera 637, and at least one display 639. The apparatus for assisting the color-blind user in perceiving colors 604 has at least one code 631 and at least one formula 633. The at least one camera 637 of the at least one mobile device 611 comprises camera data 641, at least one color 643, and a plurality of pixels 645 of the at least one color 643. The present teachings disclose that the color-blind user with an eyewear 613 may be using her at least one mobile device 611 in a public place, such as a restaurant.

Referring now generally to FIG. 6d, in one embodiment of the teachings, an apparatus for assisting a color-blind user in perceiving colors 606 is disclosed. The apparatus for assisting the color-blind user in perceiving colors 606 generally comprises the color-blind user with an eyewear 613. The eyewear 613 further comprises at least one computing device 661 that has at least one processor 663, at least one camera 665, and at least one display 667. The apparatus for assisting the color-blind user in perceiving colors 606 has at least one code 669 and at least one formula 671. The at least one camera 665 of the at least one computing device 661 comprises camera data 673, at least one color 675, and a plurality of pixels 677 of the at least one color 675.

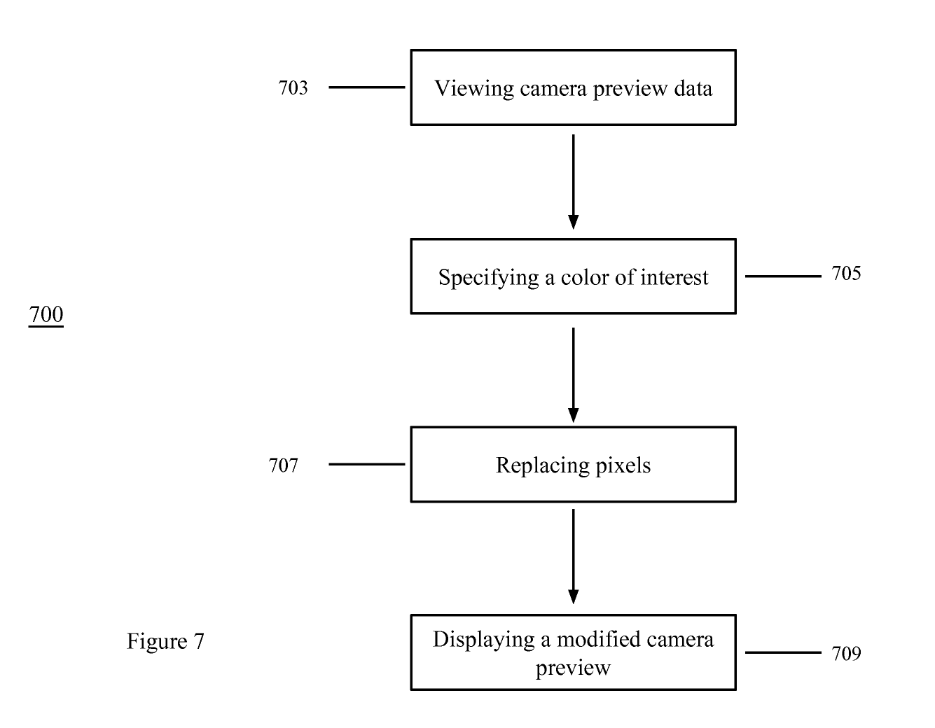

Referring now to generally to FIG. 7, in one embodiment of the teachings, a method for assisting a color-blind user in perceiving colors 700 is disclosed. The method for assisting the color-blind user in perceiving colors 700 generally comprises viewing camera preview data 703, specifying a color of interest 705, replacing pixels 707, and displaying a modified camera preview in real time 709.

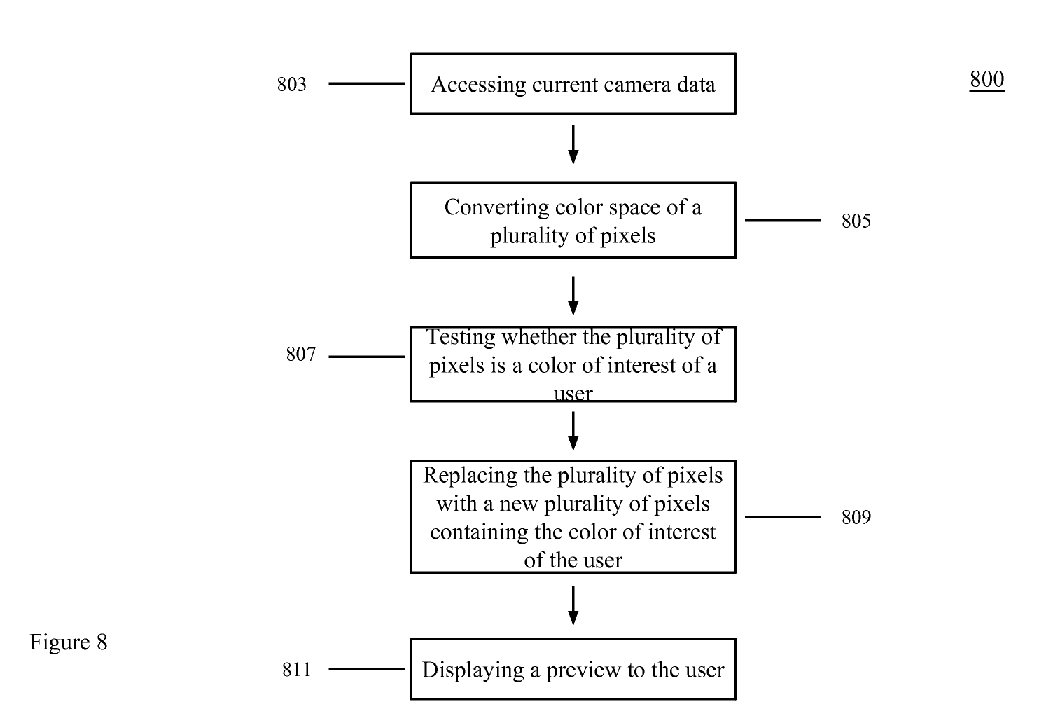

Referring now generally to FIG. 8, one embodiment of a system for assisting a color-blind user in perceiving colors 800 is disclosed. The system for assisting the color-blind user 800 generally comprises accessing current camera data 803, converting color space of a plurality of pixels to hue, saturation, and value (HSV) color space 805, testing whether the plurality of the pixels is a color of interest of a user 807, replacing the plurality of the pixels with a new plurality of the pixels containing the color of interest of the user with a formula 809, and displaying a preview to the user in real time 811.

In one embodiment, the following method is disclosed: 1. draw a crosshair in the middle of the screen; 2. get the pixel pointed by that crosshair from the real-time camera data, which is the pixel located in the middle of the screen; 3. Classify the color of that pixel using its RGB or HSV value. That is, determine the color of that pixel in English (e.g. “Red”). (Classifying colors are performed in my other features as well. There are many ways to classify colors, such as using a predetermined RGB or HSV thresholds, using some open source library, or using a classifier.); 4. display the color name in English (e.g. “Red”) on the screen.

Example use case of this feature: You want to buy a shirt. You just want to know the color of that shirt. You simply point the camera such that the crosshair points to the shirt, and the app will tell you the color of that shirt in English.

In another embodiment, a method is disclosed, comprising the steps of: 1. Perform the above disclosed steps from the previously disclosed embodiment; 2. In addition, also highlight ALL pixels in the scene that have the same color as the center pixel. For example, if the center pixel is classified as “red” in step 3 above, then highlight all red pixels in the scene. Example use case of this feature: You are looking at a color coded chart. The chart has legends, describing the meaning of each color. However, you cannot understand which colors correspond to which portions of the graph since you are colorblind. You can point the app's crosshair to the legend. The app will highlight all portions of the chart that have the same color as the legend that you are pointing to, so you can now understand the chart.

Those skilled in the art will appreciate that the present teachings may be practiced with other system configurations, including hand-held devices, multiprocessor systems, microprocessor-based or programmable consumer electronics, network PC's, minicomputers, mainframe computers, and the like. The present teachings may also be practiced in distributed computing environments where tasks are performed by remote processing devices that are linked through a communications network. In a distributed computing environment, program modules may be located in both local and remote memory storage devices.

The computer described herein above may operate in a networked environment using logical connections to one or more remote computers. These logical connections can be achieved using a communication device that is coupled to or be a part of the computer; the present teachings are not limited to a particular type of communications device. The remote computer may be another computer, a server, a router, a network PC, a client, a peer device or other common network node, and typically includes many or all of the elements described above relative to the computer. The logical connections include a local-area network (LAN) and a wide-area network (WAN). Such networking environments are commonplace in office networks, enterprise-wide computer networks, intranets and the Internet, which are all types of networks.

When used in a LAN-networking environment, the computer is connected to the local network through a network interface or adapter, which is one type of communications device. When used in a WAN-networking environment, the computer typically includes a modem, a type of communications device, or any other type of communications device for establishing communications over the wide area network, such as the Internet.

The foregoing description illustrates exemplary implementations, and novel features, of aspects for an apparatus for correcting color-blindness. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising.”

What is claimed is:

1. An apparatus for assisting a color-blind user in perceiving colors, comprising:
a.) at least one computing device;
b.) an eyewear.

2. The apparatus for assisting the color-blind user in perceiving colors of claim 1, further comprising having:
a.) at least one processor for the at least one computing device;
b.) at least one camera for the at least one computing device;
c.) at least one display for the at least one computing device.

3. The apparatus for assisting the color-blind user in perceiving colors of claim 2, further comprising having at least one code.

4. The apparatus for assisting the color-blind user in perceiving colors of claim 2, wherein the at least one camera has camera data.

5. The apparatus for assisting the color-blind user in perceiving colors of claim 4, further comprising having at least one color.

6. The apparatus for assisting the color-blind user in perceiving colors of claim 4, further comprising having a plurality of pixels of the at least one color.

7. The apparatus for assisting the color-blind user in perceiving colors of claim 4, further comprising accessing camera data.

8. The apparatus for assisting the color-blind user in perceiving colors of claim 4, further comprising having a color space for the plurality of the pixels in the camera data.

9. The apparatus for assisting the color-blind user in perceiving colors of claim 4, further comprising having a color space for a plurality of combinations of the plurality of the pixels in the camera data.

10. The apparatus for assisting the color-blind user in perceiving colors of claim 7, further comprising having the color-blind user choose at least one color of interest in human language.

11. The apparatus for assisting the color-blind user in perceiving colors of claim 7, further comprising having the color-blind user choose at least one replacement color to replace the at least one color of interest in human language.

12. The apparatus for assisting the color-blind user in perceiving colors of claim 11, further comprising determining colors of the plurality of the pixels of the at least one color in human language.

13. The apparatus for assisting the color-blind user in perceiving colors of claim 11, wherein the at least one color of interest and the at least one replacement color is specified optionally through a graphical user interface or voice commands.

14. The apparatus for assisting the color-blind user in perceiving colors of claim 11, further comprising computing the at least one color of interest in parallel to at the least one replacement color specified by the color-blind user.

15. The apparatus for assisting the color-blind user in perceiving colors of claim 11, further comprising converting the color space for the plurality of the pixels in the camera data of the at least one color of interest to the color space for a plurality of combinations of the plurality of the pixels in the camera data of the at least one replacement color.

16. The apparatus for assisting the color-blind user in perceiving colors of claim 13, further comprising mapping the at least one color of interest in parallel to the at least one replacement color specified by the color-blind user.

17. The apparatus for assisting the color-blind user in perceiving colors of claim 15, wherein the plurality of the pixels in the camera data of the at least one replacement color chosen by the color-blind user are optionally flashing or not flashing.

18. The apparatus for assisting the color-blind user in perceiving colors of claim 15, further comprising testing whether the plurality of the pixels in the camera data is the at least one replacement color chosen by the color-blind user.

19. The apparatus for assisting the color-blind user in perceiving colors of claim 18, further comprising using a formula to determine whether the plurality of the pixels in the camera data is the at least one replacement color chosen by the color-blind user.

20. The apparatus for assisting the color-blind user in perceiving colors of claim 19, further comprising using hue (H), saturation (S), value (V) as components for the formula.
